(19) United States
(12) Patent Application Publication
(10) Pub. No.: US 2007/0052994 A1
(43) Pub. Date: Mar. 8, 2007

(54) Printing in a framework

(76) Inventors: Mark A. Gullett, Castle, CO (US); Christopher Alan Mankle, Overland, KS (US); Paul Michael Burke, Bedford, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/209,217

(22) Filed: Aug. 23, 2005

(51) Int. Cl. G06F 3/12

(52) U.S. Cl. 358/1.15

(57) ABSTRACT

In one exemplary method of printing within a framework, a message identifying a printer and indicating data to be printed is sent from a user equipment to a system proxy. A message identifying the user equipment and the printer and indicating data to be printed is sent from the system proxy to a print server. The data to be printed is sent from the print server to the printer.

### BACKGROUND

Various entities are providing “hotspots,” which are places with wireless transmitters and receivers by which a user of electronic equipment such as a laptop computer or a personal digital assistant can connect to the internet or another network. Such hotspots are sometimes provided in public places without charge to the users, either as a public service or as a way of attracting people to a location.

Hotspots support various methods of communication, such as the Internet Protocol Multimedia Subsystem (IMS), a multimedia framework primarily oriented to real-time and interactive communication between users supported by the Internet Protocol (IP).

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram parts of a computer network.

FIG. 2 is a flowchart of an embodiment of a method according to the invention.

FIG. 3 is a chart of message exchanges in an embodiment of a method according to the invention.

FIG. 4 is a chart of message exchanges in an embodiment of a method according to the invention.

### DETAILED DESCRIPTION

Reference will now be made in detail to various embodiments of the present invention, examples of which are illustrated in the accompanying drawings.

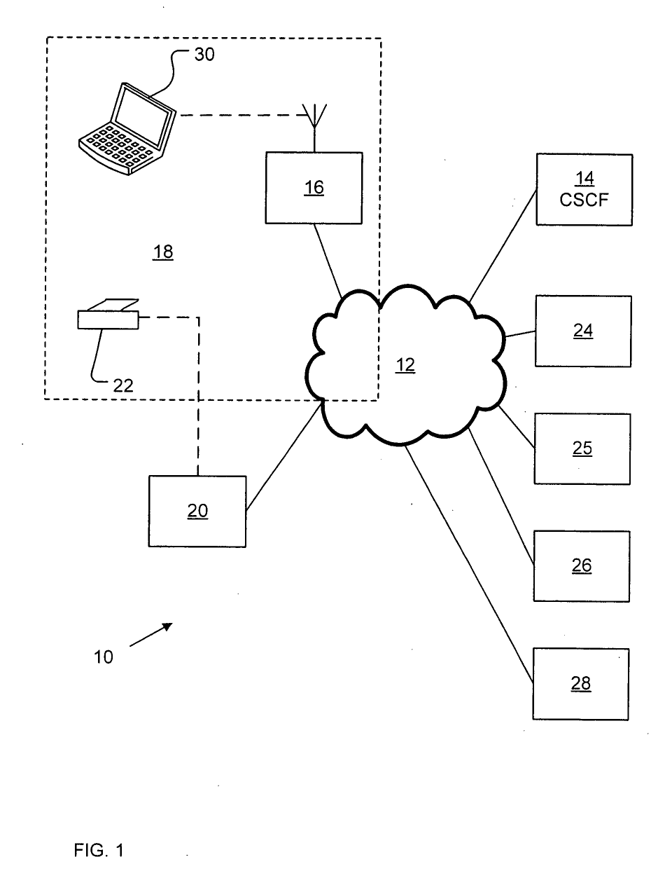

Referring to the drawings, and initially to FIG. 1, one embodiment of a computer system indicated generally by the reference numeral 10 comprises a network 12 connecting various devices. In an embodiment, the network 12 supports a multimedia framework of computing entities communicating by a communications protocol such as the Internet Protocol (IP), a messaging system such as the IP Multimedia Subsystem (IMS), and signaling messages in a messaging protocol such as Session Initiation Protocol (SIP).

The devices connected to the network 12 include a system proxy which in an embodiment may be a server 14 for the IMS Call Session Control Function (CSCF), a transmitter/receiver 16 for a wireless hotspot 18, a print server 20 controlling a printer 22 in or near the hotspot 18, and various remote servers 24, 25, 26, 28. In an embodiment, the network 12 is, includes, or is in communication with the internet, and the remote servers 24, 25, 26, 28 may be anywhere on the internet. In an embodiment, the server 24 may be a user's Home Subscriber Server (HSS), the server 25 may be a server with data stored by the user, the server 26 may be a service provider's home server, and the server 28 may be an accounting server, etc. A mobile user equipment 30, which may be, for example, a laptop computer, may be present in the hotpot 18, and may be in communication with the transmitter/receiver 16 and thereby with the network 12.

When the user equipment 30 connects to the IMS framework the user equipment 30 initially registers with the system control function 14. The system control function 14 then contacts the HSS 24 of a user identified by the user equipment 30, and obtains information about the user from a user profile stored on the HSS 24. Subsequent messages to and from the user equipment 30 are routed by the system control function 14, which uses the information about the user obtained from the HSS 24 for routing decisions. The user equipment 30 remains registered with the system control function 14 as long as the user equipment 30 is connected to the IMS framework.

In an embodiment where the system control function 14 is an IMS Proxy-CSCF, the system control function 14 may maintain a security association with the user equipment 30 so that other entities in the IMS framework may trust messages routed by the system control function 14 from the user equipment 30, without other entities needing to authenticate the user equipment 30 separately. The system control function 14 may validate messages from the user equipment 30. Validation may include verifying that the user equipment 30 is attached to the IMS framework. Validation may include verifying that the message from the user equipment 30 is directed to a valid destination within the IMS framework, such as a valid print server 20 or printer 22. Validation may include verifying that the printer 20 or other resource is available. Validation may include verifying that the user profile allows the user of the user equipment 30 to use the printer 20 or other resource to which the message is directed.

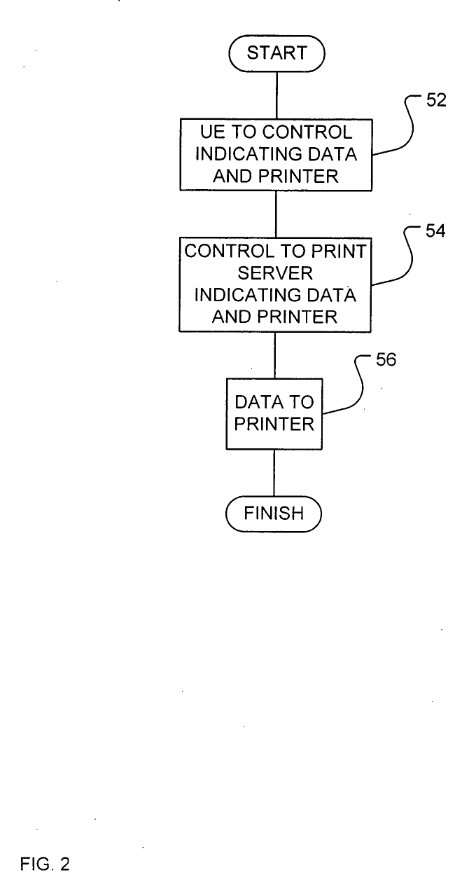

Referring now to FIG. 2, in a method embodiment of the invention, in step 52 the user equipment 30, for example, a laptop computer, sends to the system control function 14 a message identifying a printer 22 and indicating data to be printed. In an embodiment, the indication of data to be printed may be the actual information, a proposal to initiate a file transfer from the user equipment, or a URL or other identification of a location from which a print server 20 can retrieve the data. In step 54 the system control function 14 sends to the print server 20 a message identifying the user equipment 30 and the printer 22, and indicating the data to be printed. In step 56, the data to be printed are provided at the print server 20, and are sent from the print server 20 to the printer 22.

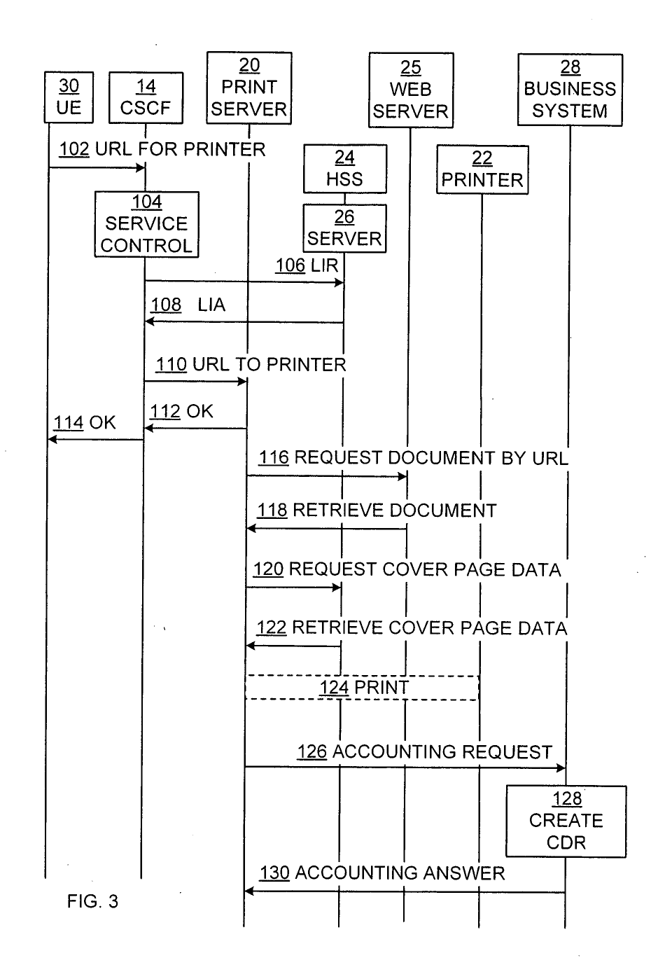

Referring now to FIG. 3, in an embodiment of a method according to the invention, a user equipment 30 is registered to a multimedia framework, which may be IMS. The user equipment 30 may be a laptop computer or a PDA. However, in the process shown in FIG. 3 the user equipment 30 may be a smaller device that is capable of sending and receiving brief messages within the multimedia framework. In step 102 the user equipment 30 sends to a call session control function (CSCF) 14 of a multimedia framework a message specifying a location of a document to be printed and a location or identity of a printer 22. The document may, for example, be stored on a data server 25. In the embodiment, the locations may be URLs. The user may, for example, read the URL of the printer 22 from a label displayed on the printer 22 and type the URL into the user equipment 30. The user may obtain the URL of the printer 22 from a database. The user equipment 30 may be automatically supplied with a list of one or more nearby printers 22 when the user equipment 30 is registered to the framework. The user equipment 30 may be provided with a printing system such as the mobile print driver described in commonly-assigned U.S. patent application Ser. No. 10/752,973 filed Jan. 7, 2004 in the name of Tim McAllister et al., which is imported herein by reference in its entirety, modified to accept a URL as a valid printer identity.

The IMS framework does not generally support the concept of a print server, but does support the concept of an application server (AS). The message in step 102 may therefore be formulated as an IMS message identifying the server 20 as an IMS application server.

In step 104, the CSCF 14 validates the message received in step 102 to ensure that the user equipment 30 is attached to the multimedia framework and the specified print server 20 is an AS that is valid, available, and allowed for the user of the user equipment 30. Where the message in step 102 specifies a printer ID, in step 106 the CSCF 14 may send a Location Info Request (LIR) requesting a Home Subscriber Server (HSS) 24 to provide in step 108 a Location Info Answer (LIA) giving the address of the print server 20 serving that printer 22. Alternatively, the CSCF 14 may obtain the address of the print server 20 from a web server 26. An HSS 24 typically contains subscriber data. An HSS 24 may also have routing information associated with services, including publicly available services. The LIR and LIA messages in steps 106, 108 may be messages based on the IETF Diameter standard that interrogate the HSS 24 for the appropriate print server 20.

In step 110, the CSCF 14 passes the message received in step 102 to the print server 20. In step 112, the print server 20 acknowledges receipt of the message to the CSCF 14, and in step 114 the CSCF passes the acknowledgement on to the user equipment 30.

In step 116, the print server 20, using the URL in the message received in step 110, requests the document to be printed from the remote server 25 on which the document resides. In step 118, the remote server 25 sends the document to the print server 20. In step 120, the print server 20 requests data from the HSS 24 and/or from the service provider's web server 26 for a cover page for the document. In step 122, the cover page data is provided. The data may include data identifying the user, other data specified by the user, information identifying the service provider operating the printer 22, and other data specified by a service provider. For example, the cover page data may include coupons or other advertising appropriate to the location of the printer. By retrieving such data from a server 24, 26 only when required for printing, the advertising or other data can be frequently updated without the overhead of keeping an up-to-date file at each print server.

In step 124, the print server 20 causes the printer 22 to print the cover page and document.

In step 126, the print server sends a message to a business system 28 reporting the printing for billing purposes. The message may include the cost of the print job, either in terms of cash price or in terms such as the number and type of pages from which the business system 28 can calculate a price. The message may also include an identification of the user from which the business system can derive billing information such as a credit card number. The user identification may comprise a reference to the user's HSS record. The ability to charge printing to a financial account external to the IMS system and its operators, such as a credit card account, enables the printing service to be used by users who do not have an account with the specific service providers operating the CSCF 14, the print server 20, or the printer 22.

In step 128, the business system 28 creates the appropriate billing transaction, and in step 130 the business system confirms to the print server 20 that the print job has been billed. In an embodiment, the billing transaction may comprise a direct charge, for example, a credit card charge, from the print server provider's billing system to the user. In an embodiment, the billing transaction may comprise a message from the print service provider's billing system 28 to an entity on the system 10 with which the user already has a billing relationship, for example, the user's usual internet service provider or e-mail provider, or the service provider of the user's data server 25.

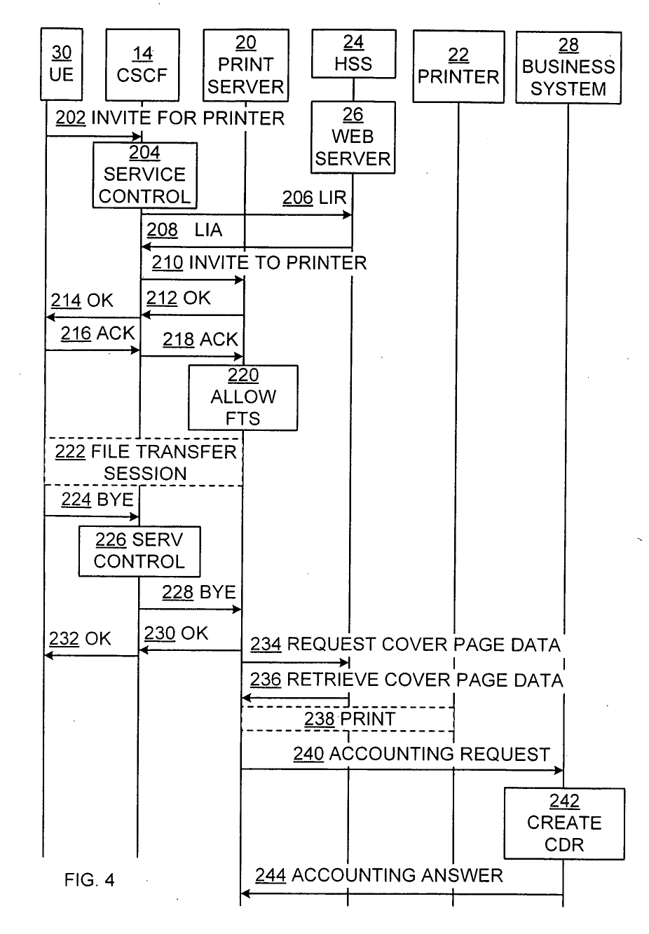

Referring now to FIG. 4, in another embodiment of a method according to the invention, a user equipment 30 is registered to a multimedia framework, which may be IMS. The user equipment 30 may be a laptop computer. In step 202 the user equipment 30 sends to a call session control function (CSCF) 14 of a multimedia framework a signaling message specifying a location or identity of a printer 22, and inviting a print server 20 to establish a file transfer session with the user equipment 30 to transfer to the print server a file to be printed. As discussed above, the message in step 202 may be formulated as an IMS message identifying the server 20 as an IMS application server. A file transfer request can be established using a standard header within an IMS INVITE method.

In step 204, the CSCF 14 validates the message received in step 202 to ensure that the user equipment 30 is attached to the multimedia framework and the specified print server 20 is valid, available, and allowed for the user of the user equipment 30. Where the message in step 202 specifies a printer ID rather than an address, in step 206 the CSCF 14 may request an HSS 24 or web server 26 to provide in step 208 the address of the print server 20 serving that printer 22.

In step 210, the CSCF 14 passes the message received in step 202 to the print server 20. In step 212, the print server 20 sends a message to the CSCF 14, and in step 214 the CSCF 14 passes the message on to the user equipment 30, agreeing to the file transfer session. In step 216 the user equipment 30 acknowledges the print server 20's agreement, and in step 218 the acknowledgement is passed on to the print server 20.

In step 220, the print server 20 verifies the acknowledgment, and prepares to accept a file transfer. In step 222, the user equipment 30 transfers the actual file to the print server 20. In step 224, the user equipment terminates the file transfer typically with a BYE message. In step 226 the CSCF 14 verifies that the file transfer was properly completed, and in step 228 the CSCF 14 forwards the BYE message to the print server 20. In steps 230 and 232, the print server 20 sends to the CSCF 14, and the CSCF 14 sends to the user equipment 30, an OK message confirming that the file, and the BYE message terminating the transfer, were properly received.

In step 234, the print server 20 requests data from the HSS 24 and/or from the web server 26 for a cover page for the document, similarly to step 120. In step 236, the cover page data is provided.

In step 238, the print server 20 causes the printer 22 to print the cover page and document.

In steps 240, 242, and 242, as in steps 126, 128, and 130, the print job is billed.

It will be apparent to those skilled in the art that various modifications and variation can be made in the present invention without departing from the spirit or scope of the invention. For example, where messages such as ACK, BYE, and OK merely serve to acknowledge receipt of an earlier message, or to confirm that an action is taken, more or fewer such messages may be sent than are shown in FIGS. 3 and 4. Because the CSCF 14 acts to a considerable extent as a proxy for other components of the system 10, the CSCF 14 may refrain from sending acknowledgement of a message until the CSCF 14 has successfully forwarded that message on to a destination component or unless the CSCF 14 is unable to forward the message.

Certain stages in the processes shown in FIGS. 3 and 4 may be omitted. For example, the cover sheet may be omitted, or a locally-generated cover sheet may be used with no more identifying information than can be derived from the messages exchanged in steps 110 and 112 or 210 and 212. For example, the billing stage may be omitted if printing is not charged for, or if the user pays directly for printing when he or she collects the printed document.

Certain stages may be carried out in different orders. For example, in FIG. 3 either the step 116 of requesting the document or step 120 of requesting the cover page data may be carried out first, at any time after the message initiating the process is received in step 110. For example, in FIG. 4 either the step 222 of transferring the document or step 234 of requesting the cover page data may be carried out first, at any time after the message initiating the process is received in step 210. For example, the print server 20 may send the billing message 126, 240 to the business system 28 as soon as the print server 20 is able to determine the quantity of billable printing, which may be shortly after the document is received in step 118 or step 222, or after step 122 or step 236. The print server 20 may then delay the printing step 124 or 238 until the business system 28 confirms in step 130 or step 244 that the transaction can be properly billed. When printing has been completed, the print server 20 may then send a further billing message 126, 240 to the business system 28 to confirm that the transaction should be billed.

In the interests of simplicity, FIGS. 3 and 4 show only one HSS 24 and one web server 26. A single network 12 may include more than one HSS 24 and/or more than one web server 26. The usual routing standards of that network 12 may then be used to locate the appropriate HSS 24 or web server 26 for a specific transaction. For example, the cover page transaction in steps 120, 122 or 234, 236 may be directed to the user's HSS 24. Where the choice of printer 22 is not affected by the identity of the user, the HSS 24 contacted to locate the printer server in steps 106, 108, 206, 208 may be an HSS 24 containing public service location data about publicly available printers 22, and may be different from the user's HSS 24. Where the identity of the user does affect the choice of printer 22, for example, because some printers 22 are not available to all users, or because some printers 22 charge a discounted price to some users, the user's HSS 24 may be contacted to locate an eligible printer 22 or printer server 20.

The functions may be differently grouped among physical entities. For example, in an IMS system the Call Session Control Function 14 includes interrogating, proxy, and serving functions. In FIGS. 3 and 4 these are shown as being provided by the single entity 14, but they may alternatively be distributed among two or more entities. The process shown in the drawings uses the CSCF 14. The CSCF 14 is a superset of the Internet Engineering Task Force standard Session Initiation Protocol (SIP) proxy. An SIP proxy may be used to provide the proxy functions that in FIGS. 3 and 4 are provided by the CSCF 14, if other provision is made for the functions provided by the CSCF 14 but not provided by the SIP proxy, such as legalized attachment of the user equipment 30 to the network and support for subscriber profiles. Further, the process may be adapted for use with other communications frameworks currently existing or contemplated or to be developed in the future.

In FIG. 1, the hotspot transmitter/receiver 16 and the print server 20 are shown as being independently connected to the network 12. The transmitter/receiver 16 and the print server 20 may physically be in a single unit with a common point of connection to the network 12, or may be in a smaller network with a common point of connection to the network 12.

Thus, it is intended that the present invention cover the modifications and variations of this invention provided they come within the scope of the appended claims and their equivalents.

What is claimed is:

1. A method for printing within a multimedia framework of computing entities, comprising:
sending from a user equipment to a system proxy a message identifying a printer and indicating data to be printed;
sending from the system proxy to a print server a message identifying the user equipment and the printer and indicating data to be printed; and
sending the data to be printed from the print server to the printer;
wherein
the computing entities comprise the system proxy to which the user equipment can connect for routing messages to and from the user equipment;
when the user equipment connects to the system proxy the system proxy contacts a server and obtains information about the user; and
the system proxy uses the information about the user for subsequent routing decisions.

2. A method according to claim 1, wherein the messages are Session Initiation Protocol (SIP) signaling messages.

3. A method according to claim 1, wherein the proxy forms part of a session control function that is arranged to validate the message from the user equipment before sending the message to the print server.

4. A method according to claim 3, wherein validating comprises at least one of verifying that the user equipment is attached to the multimedia framework, verifying that the message from the user equipment specifies a valid printer, verifying that the printer is available, and verifying that a user of the user equipment is allowed to print at the specified printer.

5. A method according to claim 3, wherein validating comprises verifying that information is provided to enable a cost of printing to be charged to a user.

6. A method according to claim 5 wherein, at least when the user does not have an account with an operator of the session control function, validating comprises verifying with a business system that the information identifies a financial account to which the cost of printing can be properly charged.

7. A method according to claim 1, further comprising transferring to the print server the data indicated in the messages.

8. A method according to claim 7, wherein the message indicating data to be printed comprises an invitation to transfer a data file from the user equipment to the print server.

9. A method according to claim 7, wherein the message indicating data to be printed comprises information specifying a location of a file containing the data, and transferring the data comprises the print server retrieving the data file.

10. A method according to claim 1, further comprising the print server sending a message to a remote server requesting cover page data, the remote server sending cover page data to the print server, and the print server generating a cover page for the data to be printed using the cover page data.

11. A method according to claim 10, wherein the cover page data comprises data associated with a user of the user equipment and is sent from a remote server location associated with the user.

12. A method according to claim 10, wherein the cover page data comprises data selected by an operator of the system proxy or of the print server.

13. A method according to claim 1, further comprising the print server sending a message to a business system identifying a user of the user equipment and indicating a charge for the printing.

14. User equipment for printing within a multimedia framework of computing entities wherein the computing entities communicate by the exchange of signaling messages, the user equipment comprising a printer driver arranged to accept a network address as a printer identity, and to send to a system proxy a signaling message in the multimedia framework identifying a printer by the network address and indicating data to be printed, and wherein
the computing entities comprise the system proxy to which the user equipment can connect for routing messages to and from the user equipment,
when the user equipment connects to the system proxy the system proxy contacts a server and obtains information about the user, and
the system proxy uses the information about the user for subsequent routing decisions.

15. User equipment according to claim 14, wherein the printer driver is arranged to send the signaling message to the system proxy in the form of an SIP message.

16. A computer readable medium having therein program code comprising instructions for printing within a multimedia framework of computing entities, the instructions comprising:
instructions for receiving at a print server from a system proxy a signaling message identifying a printer associated with the print server and indicating data to be printed; and
instructions for the print server to retrieve a file containing the data indicated in the message from a location specified in the message indicating data to be printed;
wherein the computing entities comprise the system proxy to which the user equipment can connect for routing messages to and from the user equipment;
wherein when the user equipment connects to the system proxy the system proxy contacts a server and obtains information about the user; and
wherein the system proxy uses the information about the user for subsequent routing decisions.

17. A medium according to claim 16, further comprising instructions for the print server to send a signaling message to a remote server requesting cover page data and for the print server to generate a cover page for the data to be printed using cover page data from the remote server.

18. A medium according to claim 16, further comprising instructions for the print server to send a signaling message to a business system identifying a user of the user equipment and indicating a charge for the printing.

19. A medium according to claim 16, wherein the instructions for sending and receiving signaling messages further comprise instructions for sending and receiving SIP messages.

20. A computer readable medium having therein program code comprising instructions for printing within a multimedia framework of computing entities, wherein the computing entities communicate by the exchange of signaling messages, and wherein the computing entities comprise a system proxy to which a user equipment can connect for routing messages to and from the user equipment, wherein when the user equipment connects to the system proxy the system proxy contacts a server and obtains information about the user, and wherein the system proxy uses the information about the user for subsequent routing decisions, the instructions comprising instructions for sending from the user equipment to the system proxy a message identifying a printer and indicating data to be printed.

21. A medium according to claim 19, wherein the instructions for sending and receiving signaling messages further comprise instructions for sending and receiving SIP messages.

22. A medium according to claim 19, wherein the system proxy forms part of a session control function that is arranged to validate the signaling message from the user equipment before sending the signaling message to the print server.

23. A medium according to claim 20, further comprising instructions for sending as the message indicating data to be printed a message comprising an invitation to transfer a data file from the user equipment to a print server.

24. A medium according to claim 20, further comprising instructions for sending as the message indicating data to be printed a message specifying a location of a file containing the data.

25. A medium according to claim 20, further comprising instructions for sending from the system proxy to a print server a message identifying the user equipment and the printer and indicating data to be printed.

26. A system for printing within a multimedia framework of computing entities, comprising:
user messaging means for sending a first message identifying a printer and indicating data to be printed;
system control means for connection of the user messaging means for routing of messages to and from the user messaging means, for contacting a server when the user messaging means connects to the system control means for obtaining information about the user, for using the information about the user for subsequent routing decisions, for receiving the first message and sending a second message identifying the user messaging means and the printer and indicating data to be printed; and
print serving means for receiving the second message and sending the data to be printed to the printer.

27. A system according to claim 26, wherein the print serving means further comprises means for sending a signaling message to a remote serving means requesting cover page data and for generating a cover page for the data to be printed using the cover page data.

28. A system according to claim 26, wherein the print serving means further comprises means for sending a message to a business system identifying a user of the user equipment and indicating a charge for printing.
